(19) United States
(12) Patent Application Publication
(10) Pub. No.: US 2013/0085654 A1
(43) Pub. Date: Apr. 4, 2013

(54) CONTROL APPARATUS AND CONTROL METHOD FOR VARIABLE MECHANISM

(71) Applicants: Shunsuke Yamamoto, Toyota-shi (JP); Takashi Nakagawa, Toyota-shi (JP); Shunsuke Habara, Higashihiroshima-shi (JP)

(72) Inventors: Shunsuke Yamamoto, Toyota-shi (JP); Takashi Nakagawa, Toyota-shi (JP); Shunsuke Habara, Higashihiroshima-shi (JP)

(73) Assignee: TOYOTA JIDOSHA KABUSHIKI KAISHA, Toyota-shi, Aichi-ken (JP)

(21) Appl. No.: 13/704,066

(22) PCT Filed: May 13, 2011
(86) PCT No.: PCT/IB11/01031

§ 371 Date: Dec. 13, 2012

(30) Foreign Application Priority Data
Jun. 16, 2010 (JP) 2010-137355

(51) Int. Cl. F01L 13/00; F02D 13/02

(52) U.S. Cl. CPC F01L 13/00; F02D 13/02
USPC 701/102

(57) ABSTRACT

In a control apparatus and a control method for a variable mechanism, when a predetermined condition is fulfilled, a movable member (3) is driven until an engagement portion (31) contacts one restriction member (22), and the absolute position of the movable member (3) when it is determined that displacement of the movable member (3) is stopped is learned, as a reference position. When supply of electric power is stopped, the absolute position of the movable member (3) is learned as an initial reference position. When electric power is supplied, the movable member (3) is driven from the initial reference position until the engagement portion (31) contacts the one restriction member (22), and a one-side displacement amount is calculated. If the one-side displacement amount is smaller than a one-side distance, it is determined that a foreign substance is caught in an area on a side of a site corresponding to the one restriction member (22) in a movable range.

### BACKGROUND OF THE INVENTION

1. Field of the Invention

The invention relates to a control apparatus and a control method for a variable mechanism, which calculate the amount of displacement of a movable member from a reference position, calculate the absolute position of the movable member based on the reference position and the amount of displacement of the movable member from the reference position, and control the movement of the movable member using an actuator based on the absolute position to change a predetermined mechanical characteristic of an object to be controlled.

2. Description of the Related Art

Japanese Patent Application Publication No. 2009-216052 (JP-A-2009-216052) describes an example of the control apparatus for a variable mechanism. In the publication No. 2009-216052, the variable mechanism includes a control shaft that includes an engagement portion that reciprocates between two restriction members provided on a cylinder head of an internal combustion engine; and a motor that drives the control shaft. In the variable mechanism, the motor drives the control shaft to change the maximum lift amount of an engine valve. Thus, it is important for the control apparatus for the variable mechanism to accurately control the position of the control shaft in order to control the maximum lift amount of the engine valve to a value appropriate for an engine operating state.

One example of a method of detecting the position of the control shaft is a method in which a sensor for directly detecting the absolute position of the control shaft is provided, and the absolute position of the control shaft is detected based on the output of the sensor. However, in the method, the absolute position of the control shaft detected based on the output of the sensor may deviate from the actual position due to variations in the installation position of the sensor, variations in the output of the sensor, or changes in characteristics of the sensor caused by temperature change or the like. Thus, it may not be possible to accurately detect the position of the control shaft.

In the publication No. 2009-216052, the control apparatus stores a predetermined reference position in a movable range restricted by the two restriction members, and detects the amount of displacement of the control shaft from the stored reference position using a sensor. Then, the absolute position of the control shaft is calculated based on the amount of displacement and the reference position. Also, in the publication No. 2009-216052, when a predetermined condition is fulfilled, the control apparatus drives the control shaft until the engagement portion contacts one of the two restriction members. In addition, the control apparatus learns the absolute position of the control shaft at the time at which it is determined that the displacement of the control shaft is stopped, as the reference position corresponding to the one restriction member. Thus, when the calculated absolute position of the control shaft has deviated from the actual position due to, for example, changes in the characteristics of the sensor, it is possible to make the absolute position match the actual position.

In the case where information on the position of the control shaft is lost due to the stop of the supply of electric power to the control apparatus, when the supply of electric power to the control apparatus is started thereafter, it becomes impossible to control the maximum lift amount of the engine valve to a value appropriate for the engine operating state. Thus, when the supply of electric power to the control apparatus is stopped, a non-volatile memory (for example, EEPROM) stores the absolute position of the control shaft at the time at which the operation of the motor is stopped, in order to use the absolute position of the control shaft at the time at which the operation of the motor is stopped, as an initial reference position, when the supply of electric power is started next time.

In the variable mechanism in related art, a foreign substance may be caught at a mechanism such as the control shaft or the motor. In this case, when the reference position is learned due to the fulfillment of the predetermined condition thereafter, the following situation may occur. When the control shaft is driven until the engagement portion contacts the one restriction member during the learning of the reference position, the displacement of the control shaft is stopped by the foreign substance, before the displacement of the control shaft is restricted and stopped by the one restriction member. Therefore, after the completion of the learning, the absolute position of the control shaft is calculated based on the reference position that does not correspond to the one restriction member. Accordingly, the absolute position of the control shaft deviates from the actual position. As a result, it may become impossible to control the maximum lift amount of the engine valve to a value appropriate for the engine operating state. Thus, it is desired to accurately determine whether a foreign substance is caught in an area on the side of the site corresponding to one of the two restriction members in the movable range of the movable member, which is restricted by the two restriction members.

The above-described situation may occur not only in the control apparatus for the variable mechanism that changes the maximum lift amount of the engine valve, but also in control apparatuses for variable mechanisms that change predetermined mechanical characteristics of objects to be controlled.

### SUMMARY OF THE INVENTION

The invention provides a control apparatus and a control method for a variable mechanism, which accurately determine that a foreign substance is caught in an area on a side of a site corresponding to one of two restriction members in a movable range of a movable member, which is restricted by the two restriction members, when this situation occurs.

(1) A first aspect of the invention relates to a control apparatus for a variable mechanism that includes a movable member including an engagement portion that reciprocates between two restriction members, and an actuator that drives the movable member, wherein in the variable mechanism, the actuator drives the movable body to change a predetermined mechanical characteristic of an object to be controlled. The control apparatus includes a displacement amount calculation portion that calculates an amount of displacement of the movable member from a reference position; an absolute position calculation portion that calculates an absolute position of the movable member based on the reference position and the amount of displacement of the movable member from the reference position; a movement control portion that controls movement of the movable member using the actuator based on the absolute position; a learning portion that, when a predetermined condition is fulfilled, drives the movable member until the engagement portion contacts one of the two restriction members, and learns the absolute position of the movable member at a time at which it is determined that displacement of the movable member is stopped, as the reference position corresponding to the one of the two restriction members, wherein when supply of electric power to the control apparatus is stopped, the learning portion learns the absolute position of the movable member at a time at which an operation of the actuator is stopped, as an initial reference position; a one-side displacement amount calculation portion that, when electric power is supplied to the control apparatus, drives the movable member from the initial reference position learned when the supply of electric power was stopped most recently before electric power is supplied to the control apparatus, until the engagement portion contacts the one of the two restriction members, wherein the one-side displacement amount calculation portion calculates a one-side displacement amount that is the amount of displacement of the movable member from the initial reference position until it is determined that the displacement of the movable member is stopped; a one-side distance calculation portion that calculates a one-side distance that is a distance from the initial reference position to the reference position learned due to fulfillment of the predetermined condition before the initial reference position was learned; and a determination portion that determines that a foreign substance is caught in an area on a side of a site corresponding to the one of the two restriction members in a movable range of the movable member, which is restricted by the two restriction members, if the one-side displacement amount is smaller than the one-side distance.

In the control apparatus in which when the predetermined condition is fulfilled, the movable member is driven until the engagement portion contacts one of two restriction members, and the absolute position of the movable member at the time at which it is determined that the displacement of the movable member is stopped is learned as a new reference position, if a foreign substance is caught in the area on the side of the site corresponding to the one of the two restriction members in the movable area of the variable mechanism, particularly in the movable range of the movable member, which is restricted by the two restriction members, after the reference position is learned due to the fulfillment of the predetermined condition, the movement of the movable member is restricted in the following manner. When the movable member is drive until the engagement portion contacts the one of the two restriction members, the displacement of the movable member is restricted and stopped by the foreign substance before the displacement of the movable member is stopped by the one of the two restriction members.

With the above-described configuration described in (1), when the supply of electric power to the control apparatus is stopped, the absolute position of the movable member is learned as the initial reference position. Then, when electric power is supplied to the control apparatus thereafter, the movable member is driven from the initial reference position learned when the supply of electric power was stopped most recently before electric power is supplied to the control apparatus, until the engagement portion contacts the one of the two restriction members. Then, the one-side displacement amount is calculated. The one-side displacement amount is the amount of displacement of the movable member from the initial reference position until it is determined that the displacement of the movable member is stopped. Also, the one-side distance is calculated. The one-side distance is the distance from the initial reference position to the reference position learned due to the fulfillment of the predetermined condition, that is, a position at which the displacement of the movable member was restricted by the one of the two restriction members when electric power was supplied to the control apparatus most recently before the supply of electric power was stopped. In the case where the reference position was learned due to the fulfillment of the predetermined condition when electric power was supplied to the control apparatus most recently before the supply of electric power was stopped, and a foreign substance got caught after the reference position was learned, the one-side displacement amount is smaller than the one-side distance. Accordingly, when a foreign substance is caught in the area on the side of the site corresponding to the one of the two restriction members in the movable range of the movable member, which is restricted by the two restriction members, it is possible to accurately determine that a foreign substance is caught in the area on the side of the site corresponding to the one of the two restriction members.

(2) The control apparatus according to the above-described aspect may further include a total displacement amount calculation portion that drives the movable member until the engagement portion contacts one of the two restriction members, and calculates the absolute position of the movable member at a time at which it is determined that the displacement of the movable member is stopped, and that drives the movable member until the engagement portion contacts the other of the two restriction members, calculates the absolute position of the movable member at a time at which it is determined that the displacement of the movable member is stopped, and calculates a total displacement amount that is an amount of displacement of the movable member between the two absolute positions, wherein if the total displacement amount is smaller than a predetermined determination value, the determination portion performs a determination regarding catching of the foreign substance, based on comparison between the one-side displacement amount and the one-side distance.

In the control apparatus that includes the displacement amount calculation portion that calculates the amount of displacement of the movable member from the reference position, and the absolute position calculation portion that calculates the absolute position of the movable member based on the reference position and the amount of displacement of the movable member from the reference position, the calculated absolute position of the movable member may deviate from the actual position due to, for example, a change of the characteristic of a sensor that constitutes the displacement amount calculation portion. In the case where the calculated absolute position of the movable member deviates from the actual position, even if no foreign substance is caught in the area on the side of the site corresponding to the one of the two restriction members in the movable range of the movable member, which is restricted by the two restriction members, the one-side displacement amount may be smaller than the one-side distance, and as a result, it may be erroneously determined that a foreign substance is caught.

In this regard, with the above-described configuration described in (2), when the determination is performed, the movable member is driven until the engagement portion contacts the one of the two restriction members, and the absolute position of the movable member at the time at which it is determined that the displacement of the movable member is stopped is calculated. Also, the movable member is driven until the engagement portion contacts the other of the two restriction members, and the absolute position of the movable member at the time at which it is determined that the displacement of the movable member is stopped is calculated. Then, the amount of displacement of the movable member between the two absolute positions is calculated as the total displacement amount. If the total displacement amount is smaller than the predetermined determination value, there is a high possibility that a foreign substance is caught in the movable range of the movable member, which is restricted by the two restriction members. Therefore, the determination is performed based on the comparison between the one-side displacement amount and the one-side distance. Thus, it is possible to reduce the possibility of making an erroneous determination that a foreign substance is caught when no foreign substance is caught.

(3) The predetermined determination value may be set based on a measured value of a distance of the movable range restricted by the two restriction members. Note that the distance of the movable range, which is restricted by the two restriction members, may be measured immediately after the variable mechanism is assembled. For example, the distance of the movable range may be measured at the time of shipment from a factory.

(4) In the control apparatus according to the above-described aspects, if the determination portion determines that a foreign substance is caught in the area on the side of the site corresponding to the one of the two restriction members in the movable range of the movable member, which is restricted by the two restriction members, the control apparatus may calculate a size of the foreign substance based on a difference between the one-side distance and the one-side displacement amount, and the control apparatus may correct the movable range of the movable member so as to decrease the movable range based on the size of the foreign substance.

If the control that operates the variable mechanism is continued after it is determined that a foreign substance is caught in the area on the side of the site corresponding to the one of the two restriction members in the movable range of the movable member, which is restricted by the two restriction members, the following situation may occur. If the reference position is newly learned due to the fulfillment of the predetermined condition after it is determined that a foreign substance is caught in the area on the side of the site corresponding to the one of the two restriction members, the absolute position of the movable member calculated based on the newly learned reference position deviates from the actual position due to the foreign substance being caught, after the completion of the learning. As a result, it becomes impossible to appropriately change a predetermined mechanical characteristic of an object to be controlled.

In this regard, with the above-described configuration described in (4), when the reference position is learned due to the fulfillment of the predetermined condition, the movable range of the movable member is corrected so as to be decreased based on the calculated size of the foreign substance. Accordingly, if the reference position is learned due to the fulfillment of the predetermined condition after it is determined that a foreign substance is caught in the area on the side of the site corresponding to the one of the two restriction members, it is possible to reduce the possibility that the absolute position of the movable member calculated based on the newly learned reference position deviates from the actual position, after the completion of the learning. Also, as the size of the foreign substance that is caught becomes larger, the calculated one-side displacement amount becomes smaller with respect to the one-side distance. Therefore, the size of the foreign substance is accurately calculated based on the difference between the one-side distance and the one-side displacement amount.

(5) In the control apparatus according to the above-described aspect, if the calculated size of the foreign substance is larger than a predetermined value, the control apparatus may output a warning command.

Even in the case where the size of the foreign substance caught in the area on the side of the site corresponding to the one of the two restriction members in the movable range of the movable member, which is restricted by the two restriction members, is calculated and the movable range of the movable member is corrected so as to be decreased based on the size of the foreign substance, if the size of the foreign substance is excessively large, it is not possible to appropriately change the predetermined mechanical characteristic of the object to be controlled.

In this regard, with the above-described configuration described in (5), if the calculated size of the foreign substance is larger than the predetermined value, the warning command is output. Therefore, when the predetermined mechanical characteristic of the object to be controlled cannot be appropriately changed, it is possible to quickly notify the driver of this situation.

(6) In the control apparatus according to the above-described aspects, the predetermined determination value may be set based on a measured value of a distance of the movable range restricted by the two restriction members; and if the total displacement amount is smaller than the predetermined determination value and the one-side displacement amount is equal to the one-side distance, the determination portion may determine that a foreign substance is caught in an area on a side of a site corresponding to the other of the two restriction members in the movable range of the movable member, which is restricted by the two restriction members.

If the total displacement amount is smaller than the predetermined determination value and the one-side displacement amount is equal to the one-side distance, there is a high possibility that a foreign substance is caught in the area on the side of the site corresponding to the other of the two restriction members in the movable range of the movable member, which is restricted by the two restriction members. In this regard, with the above-described configuration described in (6), it is possible to accurately determine that a foreign substance is caught in the area on the side of the site corresponding to the other of the two restriction members in the movable range of the movable member, which is restricted by the two restriction members.

(7) In the control apparatus according to the above-described aspect, if the determination portion determines that a foreign substance is caught in the area on the side of the site corresponding to the other of the two restriction members in the movable range of the movable member, which is restricted by the two restriction members, the control apparatus may calculate a size of the foreign substance based on a difference between the predetermined determination value and the total displacement amount, and the control apparatus may correct the movable range of the movable member so as to decrease the movable range based on the size of the foreign substance.

If the control that operates the variable mechanism is continued after it is determined that a foreign substance is caught in the area on the side of the site corresponding to the other of the two restriction members in the movable range of the movable member, which is restricted by the two restriction members, the following situation may occur. Because the control apparatus permits the movable member to be driven in the entire movable range, for example, if an attempt is made to drive the movable member until the engagement portion contacts the other of the two restriction members, the displacement of the movable member is restricted by the foreign substance, and thus, it becomes impossible to appropriately change the predetermined mechanical characteristic of the object to be controlled.

In this regard, with the above-described configuration described in (7), if it is determined that a foreign substance is caught in the area on the side of the site corresponding to the other of the two restriction members in the movable range of the movable member, which is restricted by the two restriction members, the size of the foreign substance is calculated based on the difference between the predetermined determination value and the total displacement amount, and the movable range of the movable member is corrected so as to be decreased based on the size of the foreign substance. That is, as the size of the foreign substance that is caught becomes larger, the calculated total displacement amount becomes smaller with respect to the predetermined determination value, and therefore, the size of the foreign substance is accurately calculated based on the difference between the predetermined determination value and the total displacement amount. Accordingly, the control apparatus drives the movable member in the movable range in which the area on the side of the site corresponding to the other of the two restriction members has been corrected so as to be decreased. Thus, it is possible to accurately correct the movable range taking into account the foreign substance that is caught. Therefore, it is possible to reduce the possibility that the predetermined mechanical characteristic of the object to be controlled cannot be appropriately changed.

(8) In the control apparatus according to the above-described aspects, the predetermined determination value may be set based on a measured value of a distance of the movable range restricted by the two restriction members; and if the total displacement amount is smaller than the predetermined determination value and a difference between the one-side distance and the one-side displacement amount is smaller than a difference between the predetermined determination value and the total displacement amount, the determination portion may determine that a foreign substance is caught in an area on a side of a site corresponding to the other of the two restriction members in the movable range of the movable member, which is restricted by the two restriction members.

If the total displacement amount is smaller than the predetermined determination value, and the difference between the one-side distance and the one-side displacement amount is equal to the difference between the predetermined determination value and the total displacement amount, there is a high possibility that a foreign substance is caught only in the area on the side of the site corresponding to the one of the two restriction members in the movable range of the movable member, which is restricted by the two restriction members. If the total displacement amount is smaller than the predetermined determination value, and the difference between the one-side distance and the one-side displacement amount is smaller than the difference between the predetermined determination value and the total displacement amount, there is a high possibility that a foreign substance is caught in the area on the side of the site corresponding to the other of the two restriction members in the movable range of the movable member, which is restricted by the two restriction members. In this regard, with the above-described configuration described in (8), it is possible to accurately determine that a foreign substance is caught in the area on the side of the site corresponding to the other of the two restriction members in the movable range of the movable member, which is restricted by the two restriction members.

(9) In the control apparatus according to the above-described aspect, if the determination portion determines that a foreign substance is caught in the area on the side of the site corresponding to the other of the two restriction members in the movable range of the movable member, which is restricted by the two restriction members, the control apparatus may calculate a size of the foreign substance based on a difference between a total difference and a one-side difference, and the control apparatus may correct the movable range of the movable member so as to decrease the movable range based on the size of the foreign substance, the total difference being a difference between the predetermined determination value and the total displacement amount, and the one-side difference being a difference between the one-side distance and the one-side displacement amount.

With the above-described configuration, it is possible to obtain the advantageous effects similar to the advantageous effects obtained when the configuration described in (7) is employed.

(10) In the control apparatus according to the above-described aspect, if the calculated size of the foreign substance is larger than a predetermined value, the control apparatus may output a warning command.

Even in the case where the size of the foreign substance caught in the area on the side of the site corresponding to the other of the restriction members in the movable range of the movable member, which is restricted by the two restriction members, is calculated and the movable range of the movable member is corrected so as to be decreased based on the size of the foreign substance, if the size of the foreign substance is excessively large, it is not possible to appropriately change the predetermined mechanical characteristic of the object to be controlled.

In this regard, with the above-described configuration described in (10), if the calculated size of the foreign substance is larger than the predetermined value, the warning command is output. Therefore, when the predetermined mechanical characteristic of the object to be controlled cannot be appropriately changed, it is possible to quickly notify the driver of this situation.

(11) The variable mechanism may change a characteristic of a valve of an internal combustion engine.

(12) A second aspect of the invention relates to a control method for a variable mechanism that includes a movable member including an engagement portion that reciprocates between two restriction members, and an actuator that drives the movable member, wherein in the variable mechanism, the actuator drives the movable body to change a predetermined mechanical characteristic of an object to be controlled, and the control method is performed by a control apparatus. The control method includes calculating an amount of displacement of the movable member from a reference position; calculating an absolute position of the movable member based on the reference position and the amount of displacement of the movable member from the reference position; controlling movement of the movable member using the actuator based on the absolute position; when a predetermined condition is fulfilled, driving the movable member until the engagement portion contacts one of the two restriction members, and learning the absolute position of the movable member at a time at which it is determined that displacement of the movable member is stopped, as the reference position corresponding to the one of the two restriction members; when supply of electric power to the control apparatus is stopped, learning the absolute position of the movable member at a time at which an operation of the actuator is stopped, as an initial reference position; when electric power is supplied to the control apparatus, driving the movable member from the initial reference position learned when the supply of electric power was stopped most recently before electric power is supplied to the control apparatus, until the engagement portion contacts the one of the two restriction members, and calculating a one-side displacement amount that is the amount of displacement of the movable member from the initial reference position until it is determined that the displacement of the movable member is stopped; calculating a one-side distance that is a distance from the initial reference position to the reference position learned due to fulfillment of the predetermined condition before the initial reference position was learned; and determining that a foreign substance is caught in an area on a side of a site corresponding to the one of the two restriction members in a movable range of the movable member, which is restricted by the two restriction members, if the one-side displacement amount is smaller than the one-side distance.

### BRIEF DESCRIPTION OF DRAWINGS

Features, advantages, and technical and industrial significance of exemplary embodiments of the invention will be described below with reference to the accompanying drawings, in which like numerals denote like elements, and wherein:

FIG. 1 is a block diagram showing the schematic configuration of a control apparatus for a variable mechanism according to an embodiment of the invention;

FIG. 2 is a timing chart showing changes in parameters while a motor is rotated in the embodiment, portions (a) to (c) showing changes in pulse signals output from electric angle sensors, portions (d) and (e) showing changes in pulse signals output from position sensors, a portion (f) showing a change in an electric angle counter value, a portion (g) showing a change in a position counter value, and a portion (h) showing a change in a stroke counter value;

FIG. 3A is a table showing a corresponding relation between the patterns of signals output from the electric angle sensors and the electric angle counter value in the embodiment, and FIG. 3B is a table showing a corresponding relation between occurrence of edges in signals output from the position sensors and a manner in which the position counter value increases and decreases in the embodiment;

FIG. 4 is a flowchart showing steps of a foreign substance catch determination process in the embodiment;

FIG. 5 is a flowchart showing steps of the foreign substance catch determination process in the embodiment; and

FIG. 6 is a schematic diagram used to explain advantageous effects obtained in the embodiment; and

FIG. 7 is a schematic diagram used to explain advantageous effects obtained in the embodiment.

### DETAILED DESCRIPTION OF EMBODIMENTS

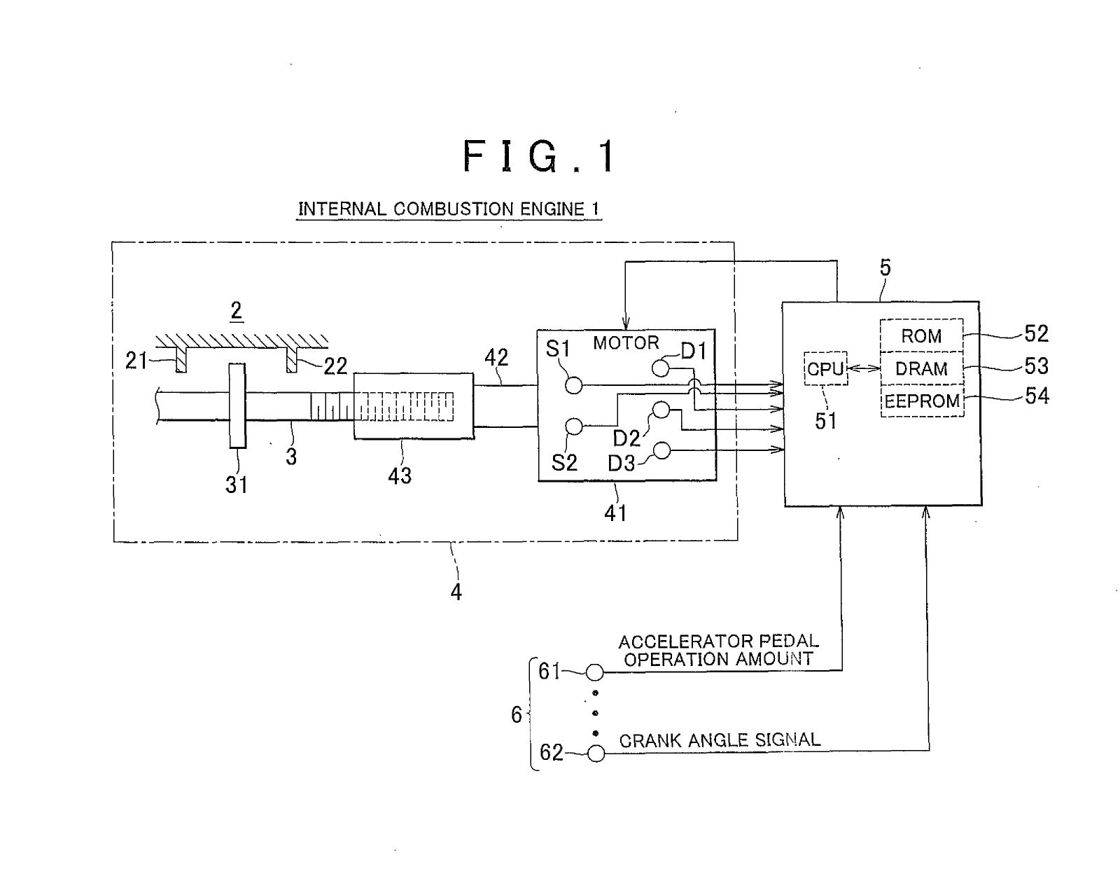

Hereinafter, a control apparatus for a variable mechanism according to an embodiment of the invention will be described in detail with reference to FIG. 1 to FIG. 7. In the embodiment, the control apparatus for a variable mechanisms according to the invention is embodied as a control apparatus for a variable mechanism that changes the maximum lift amount of an intake valve of an internal combustion engine provided in a vehicle.

FIG. 1 schematically shows the configuration of the control apparatus for the variable mechanism according to the embodiment of the invention. As shown in FIG. 1, a variable mechanism 4, an electronic control unit 5, and sensors 6 are provided for an internal combustion engine 1. The variable mechanism 4 changes the maximum lift amount of the intake valve. The electronic control unit 5 controls the manner in which the variable mechanism 4 is operated. The sensors 6 detect the operating state of the internal combustion engine 1 (hereinafter, referred to as “the engine operating state”).

The variable mechanism 4 includes a control shaft 3; a motor 41 provided at a proximal end portion (a right end portion in FIG. 1) of the control shaft 3; and a conversion mechanism 43 that is connected to an output shaft 42 of the motor 41 to convert the rotational movement of the output shaft 42 to the linear movement of the control shaft 3 in the axial direction of the control shaft 3. An engagement portion 31 is provided at the control shaft 3 to protrude in a direction orthogonal to the axial direction thereof.

The electronic control unit 5 controls the maximum lift amount of the intake valve through feedback based on the engine operating state, by controlling the operation of the motor 41. Next, the manner in which the electronic control unit 5 controls the maximum lift amount will be described in detail.

When the output shaft 42 of the motor 41 is rotated in a positive direction or a reverse direction, the conversion mechanism 43 converts the rotation to the reciprocating movement of the control shaft 3 in the axial direction thereof. A mediating operation mechanism (not shown) is connected to a distal end portion (a left end portion in FIG. 1) of the control shaft 3, in order to change the maximum lift amount of the intake valve. When the control shaft 3 is displaced in the axial direction thereof, the manner in which the mediating operation mechanism is operated is changed according to the position of the control shaft 3 in the axial direction. Thus, the maximum lift amount of the intake valve is changed. That is, the maximum lift amount of the intake valve is changed according to the amount of displacement of the control shaft 3 in the axial direction.

A Hi end-side stopper 21 and a Lo end-side stopper 22 are formed on a cylinder head cover 2 of the internal combustion engine 1. The stoppers 21 and 22 are provided at a predetermined interval in the axial direction of the control shaft 3. The control shaft 3 is provided in a manner such that the engagement portion 31 is positioned between the two stoppers 21 and 22. Thus, the control shaft 3 is displaced in a manner such that the engagement portion 31 reciprocates between the two stoppers 21 and 22. The output shaft 42 of the motor 41 can be rotated in the positive direction and the reverse direction between two rotation limit phases corresponding to the above-described two displacement limit positions.

More specifically, when the control shaft 3 is displaced in such a direction as to approach the mediating operation mechanism (i.e., a direction toward the left in FIG. 1), the Hi end-side stopper 21 contacts the engagement portion 31, and thus, the Hi end-side stopper 21 functions as the displacement limit position of the control shaft 3. When the control shaft 3 is driven until the engagement portion 31 contacts the Hi end-side stopper 21, the maximum lift amount of the intake valve becomes largest.

When the control shaft 3 is displaced in a direction away from the mediating operation mechanism (i.e., a direction toward the right in FIG. 1), the Lo end-side stopper 22 contacts the engagement portion 31, and thus, the Lo end-side stopper 22 functions as the displacement limit position of the control shaft 3. When the control shaft 3 is driven until the engagement portion 31 contacts the Lo end-side stopper 22, the maximum lift amount of the intake valve becomes smallest.

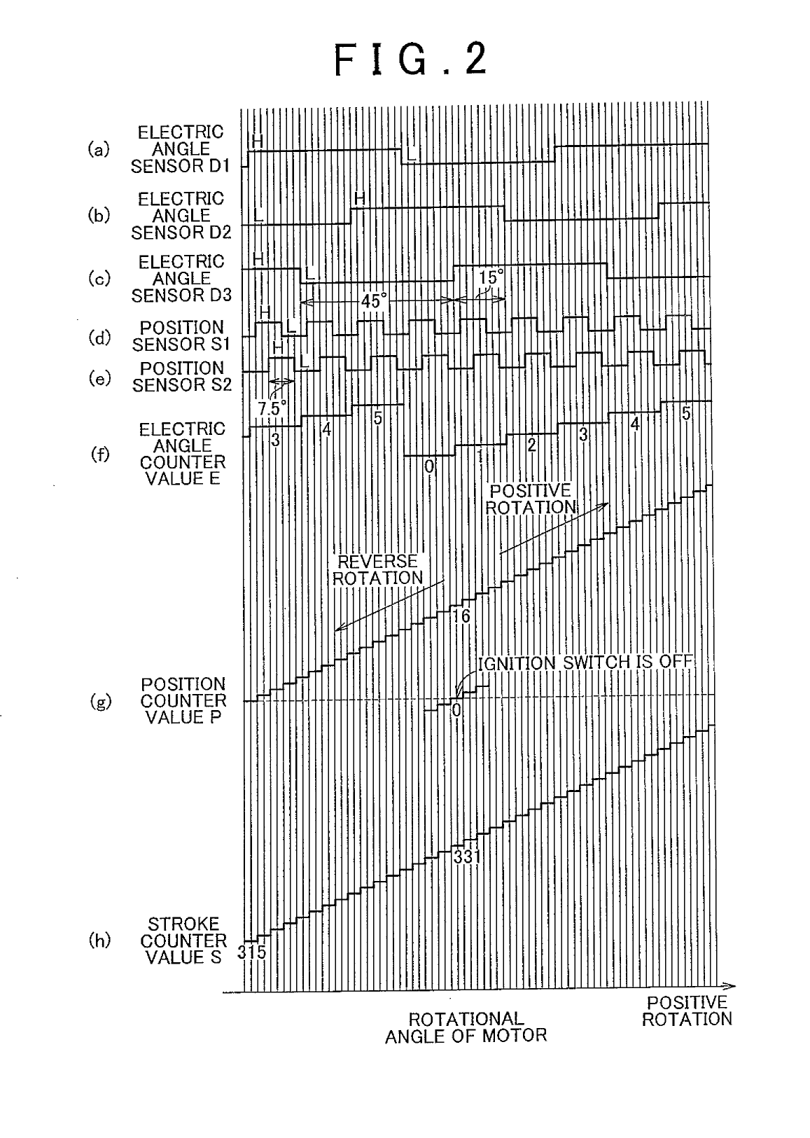

In the motor 41, three electric angle sensors D1 to D3 are provided, and a multipole magnet (not shown) with eight poles is provided. The multipole magnet corresponds to the electric angle sensors D1 to D3, and is rotated integrally with the output shaft 42. The electric angle sensors D1 to D3 output pulse signals shown in portions (a) to (c) of FIG. 2, that is, each of the electric angle sensors D1 to D3 alternately outputs a logical high level signal “H” and a logical low level signal “L”, in accordance with the magnetism of the multipole magnet with eight poles. The three electric angle sensors D1 to D3 are disposed at intervals of 120° in the rotational direction of the output shaft 42 so as to obtain the waveforms of the pulse signals. Accordingly, the edge occurs in the pulse signal output from one of the electric angle sensors D1 to D3 each time the output shaft 42 rotates by 45°. The phase of the pulse signal output from one of the electric angle sensors D1 to D3 is advanced by 30° of rotation of the output shaft 42 with respect to the phase of the pulse signal output from one of the rest of the electric angle sensors D1 to D3, and is delayed by 30° of rotation of the output shaft 42 with respect to the phase of the pulse signal output from the other of the rest of the electric angle sensors D1 to D3.

In the motor 41, two position sensors S1 and S2, which function as encoders, are provided, and further, a multipole magnet (not shown) with forty-eight poles is provided. The multipole magnet with forty-eight poles corresponds to the position sensors S1 and S2, and is rotated integrally with the output shaft 42. The position sensors S1 and S2 output pulse signals, that is, each of the position sensors S1 and S2 alternately outputs the logical high level signal “H” and the logical low level signal “L”, in accordance with the magnetism of the multipole magnet with forty-eight poles. The position sensors S1 and S2 are disposed at an interval of 176.25° in the rotational direction of the output shaft 42 so as to obtain the waveforms of she pulse signals. Accordingly, the edge occurs in the pulse signal output from one of the position sensors S1 and S2 each time the output shaft 42 rotates by 7.5°. The phase of the pulse signal output from the position sensor S2 is advanced by 3.75° of rotation of the output shaft 42, with respect to the phase of the pulse signal output from the position sensor S1, and is delayed by 3.75° of rotation of the output shaft 42, with respect to the phase of the pulse signal output from the position sensor S1.

When the pulse signals output from the electric angle sensors D1 to D3 are overlapped with each other, the interval between the edges in the pulse signals is 15°. In contrast, when the pulse signals output from the position sensors S1 and S2 are overlapped with each other, the interval between the edges in the pulse signals is 3.75°. Accordingly, four edges occur in the overlapped pulse signals output from the position sensors S1 and S2 during the period from when the edge occurs in the overlapped pulse signals output from the electric angle sensors D1 to D3 until when the next edge occurs in the overlapped pulse signals output from the electric angle sensors D1 to D3.

The pulse signals output from the electric angle sensors D1 to D3 and the position sensors S1 and S2 are taken into the electronic control unit 5. The electronic control unit 5 includes a Central Processing Unit (CPU) 51 that performs, for example, numerical calculation and logical operation according to programs; a non-volatile memory (ROM) 52 that stores programs and data required for controls; a volatile memory (DRAM) 53 that temporarily stores input data and results of calculation; and a non-volatile memory (EEPROM) 54 that is rewritable, and that stores, for example, a reference position obtained by a learning control.

The electronic control unit 5 is connected to the sensors 6 that detect the engine operating state, such as an accelerator sensor 61 that detects the operation amount of an accelerator pedal of the vehicle, and a crank angle sensor 62 that detects the rotational phase of the crankshaft of the internal combustion engine 1. The electronic control unit 5 sets a control target value of the maximum lift amount of the intake valve based on the engine operating state. In addition, the electronic control unit 5 detects the rotational phase of the motor 41, that is, the absolute position of the control shaft 3, based on the pulse signals output from the electric angle sensors D1 to D3 and the position sensors S1 and S2.

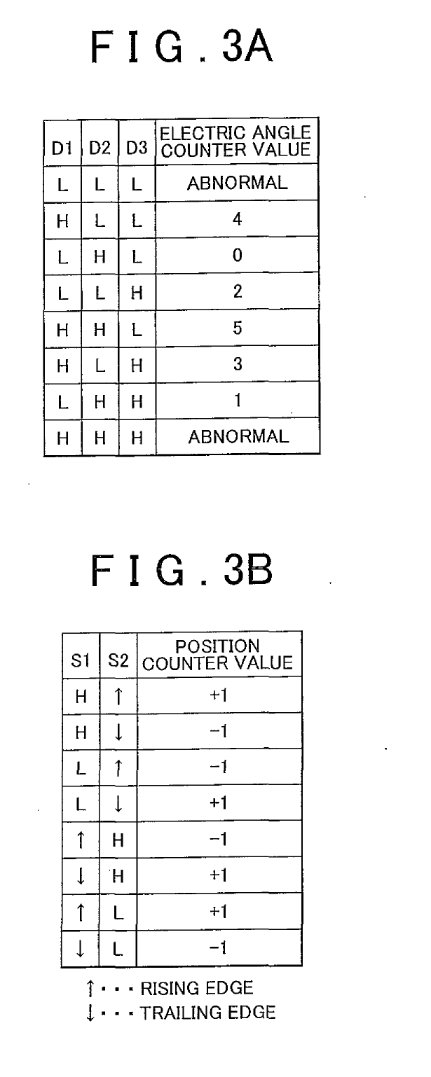

Next, a procedure for detecting the rotational phase of the motor 41 will be described in detail with reference to FIG. 2 and FIG. 3. Portions (a) to (e) of FIG. 2 show the waveforms of the pulse signals output from the electric angle sensors D1 to D3 and the position sensors S1 and S2 when the motor 41 is rotated. Portions (f) to (h) of FIG. 2 show the patterns of changes in an electric angle counter value E, a position counter value P, and a stroke counter value S with respect to the change in the rotational phase of the motor 41.

FIG. 3A shows a corresponding relation between the patterns of the signals output from the electric angle sensors D1 to D3 and the electric angle counter value E. FIG. 3B shows the manner in which the position counter value P increases and decreases when the edges occur in the signals output from the position sensors S1 and S2.

First, each counter value will be described with reference to FIG. 2.

Electric Angle Counter Value E

The electric angle counter value E is determined based on the pulse signals output from the electric angle sensors D1 to D3, and indicates the rotational phase of the motor 41. More specifically, as shown in FIG. 3A, the electric angle counter value E is set to one of consecutive integer values in the range of “0” to “5”, according to which of the logical high level signal “H” and the logical low level signal “L” is output from each of the electric angle sensors D1 to D3. The electronic control unit 5 detects the rotational phase of the motor 41 based on the electric angle counter value E, and rotates the motor 41 in the positive direction or the reverse direction by switching the phase to which electric power is supplied. When the motor 41 is rotated in the positive direction, the electric angle counter value E changes in an ascending order, that is, the electric angle counter value E changes from “0” to “1”, “2”, “3”, “4”, “5”, and “0” in the stated order. When the motor 41 is rotated in the reverse direction, the electric angle counter value E changes in a descending order, that is, the electric angle counter value E changes from “5” to “4”, “3”, “2”, “1”, “0”, and “5” in the stated order.

Position Counter Value P

The position counter value P indicates the amount of change in the rotational phase of the output shaft 42 with respect to a reference rotational phase of the output shaft 42, which will be described later. More specifically, as shown in FIG. 3B, the value “+1” or the value “−1” is added to the position counter value P, according to which of the rising edge and the trailing edge occurs in the pulse signal output from one of the position sensors S1 and S2, and which of the logical high level signal “H” and the logical 10w level signal “L” is output from the other of the position sensors S1 and S2. In FIG. 3B, an upward arrow indicates the rising edge in the pulse signal, and a downward arrow indicates the trailing edge in the pulse signal. The position counter value P obtained by performing the above-described process is a value obtained by counting the number of the edges in the pulse signals output from the position sensors S1 and S2.

When the motor 41 is rotating in the positive direction, the position counter value P is increased as shown in the portion (g) of FIG. 2 by adding “1” to the position counter value P each time the edge occurs in the pulse signals output from the position sensors S1 and S2 shown in the portions (d) and (e) of FIG. 2.

When the motor 41 is rotating in the reverse direction, the position counter value P is decreased as shown in the portion (g) of FIG. 2 by subtracting “1” from the position counter value P each time the edge occurs in the pulse signals output from the position sensors S1 and S2 shown in the portions (d) and (e) of FIG. 2.

The position counter value P is reset to “0” when a power supply stop command for stopping the supply of electric power to the electronic control unit 5 is output. Accordingly, the position counter value P indicates how much the rotational phase of the output shaft 42 of the motor 41 has changed with respect to the reference rotational phase. In other words, the position counter value P indicates how much the maximum lift amount of the intake valve has changed during the operation of the engine, with respect to a reference lift amount at the time at which the supply of electric power to the electronic control unit 5 is started.

The position counter value P needs to be increased and decreased quickly in order to quickly change the maximum lift amount of the intake valve. Therefore, the position counter value P is stored in the DRAM 53 in which a rewriting process is performed at high speed.

Stroke Counter Value S

The stroke counter value S indicates the rotational phase of the motor 41 in the case where the reference rotational phase (0 degree) is set to the rotational phase of the output shaft 42 at the time at which the control shaft 3 is displaced until the engagement portion 31 of the control shaft 3 contacts the Lo end-side stopper 22. That is, when a predetermined learning condition is fulfilled, the electronic control unit 5 drives the control shaft 3 until the engagement portion 31 of the control shaft 3 contacts the Lo end-side stopper 22. When it is determined that the displacement of the control shaft 3 is stopped, the electronic control unit 5 sets the stroke counter value S to “0” corresponding to the Lo end-side stopper 22 (hereinafter, this process will be referred to as “Lo end learning process”). Also, the electronic control unit 5 adds the position counter value P to the stroke counter value S, and thus, updates the stroke counter value S to a value obtained by adding the position counter value P to the stroke counter value S. In order to perform the Lo end learning process at least one time during a period from when a process of starting the engine is started until the engine operation is stopped, for example, the above-described predetermined learning condition may be fulfilled when a predetermined time has elapsed after the completion of the process of starting the engine.

A contact failure may occur in a power supply circuit of the electronic control 5 unit due to the vibration of a vehicle body or the internal combustion engine 1, and as a result, the supply of electric power to the DRAM 53 may be temporarily stopped, that is, so-called instantaneous interruption may occur. In this case, when the supply of electric power is resumed after the instantaneous interruption occurs, the position counter value P stored in the DRAM 53 may be changed or lost. Therefore, when the supply of electric power is resumed after the instantaneous interruption occurs, the above-described predetermined learning condition is regarded as being fulfilled, and thus, the Lo end learning process is performed. Thus, the stroke counter value S and the position counter value P are reset to correct values.

When the supply of electric power to the electronic control unit 5 is stopped, the stroke counter value S at the time at which the operation of the motor 41 is stopped is stored in the EEPROM 54, in order to use the stroke counter value S at the time at which the operation of the motor 41 is stopped, as an initial reference rotational phase SGstop, when the supply of electric power is started next time.

Thus, the electronic control unit 5 calculates the stroke counter value S based on the initial reference rotational phase SGstp stored in the EEPROM 54 and the position counter value P stored in the DRAM 53. Then, the electronic control unit 5 calculates the actual value of the maximum lift amount of the intake valve based on the stroke counter value S, and controls the operation of the motor 41 to decrease a difference between the actual value and the control target value set based on the engine operating state. Thus, it is possible to change the maximum lift amount of the intake valve to a value appropriate for the engine operating state, thereby improving the fuel efficiency and output of the internal combustion engine 1.

The position counter value P may be regarded as the amount of displacement of a movable member according to the invention. The stroke counter value S may be regarded as the absolute position of the movable member according to the invention. The reference rotational phase may be regarded as a reference position according to the invention. The initial reference rotational phase may be regarded as an initial reference position or a one-side distance according to the invention.

A foreign substance may be caught at a mechanism such as the control shaft 3 or the motor 41. In this case, if the Lo end learning process is performed due to fulfillment of the predetermined learning condition after a foreign substance is caught at a mechanism, there is a possibility that the following situation may occur. When the control shaft 3 is driven until the engagement portion 31 contacts the Lo end-side stopper 22 during the Lo end learning process, the displacement of the control shaft 3 is restricted and stopped by the foreign substance before the displacement of the control shaft 3 is restricted and stopped by the Lo end-side stopper 22. Therefore, after the Lo end learning process is completed, the stroke counter value S is set to “0” at the phase that does not correspond to the Lo end-side stopper 22, and then, the stroke counter value S of the control shaft 3 is calculated. Thus, the stroke counter value S deviates from the actual position. As a result, there is a possibility that the maximum lift amount of the engine valve cannot be controlled to a value appropriate for the engine operating state. Particularly, in the case where a foreign substance is caught in an area on the side of a site corresponding to the Lo end-side stopper 22 in the movable range of the control shaft 3, which is restricted by the Hi end-side stopper 21 and the Lo end-side stopper 22, when the Lo end learning process is performed and the maximum lift amount of the engine valve is controlled based on the reference rotational phase that has been erroneously learned, the maximum lift amount of the intake valve may be excessively increased, and as a result, the intake valve may collide with a piston, that is, so-called valve stamp may occur. Accordingly, it is desired to accurately determine whether a foreign substance is caught in the area on the side of the site corresponding to the Lo end-side stopper 22 in the movable range of the control shaft 3, which is restricted by the Hi end-side stopper 21 and the Lo end-side stopper 22.

Thus, in the embodiment, when a foreign substance is caught in the area on the side of the site corresponding to the Lo end-side stopper 22 in the movable range of the control shaft 3, which is restricted by the Hi end-side stopper 21 and the Lo end-side stopper 22, it is accurately determined that a foreign substance is caught in the area on the side of the site corresponding to the Lo end-side stopper 22, by performing a foreign substance catch determination process described below.

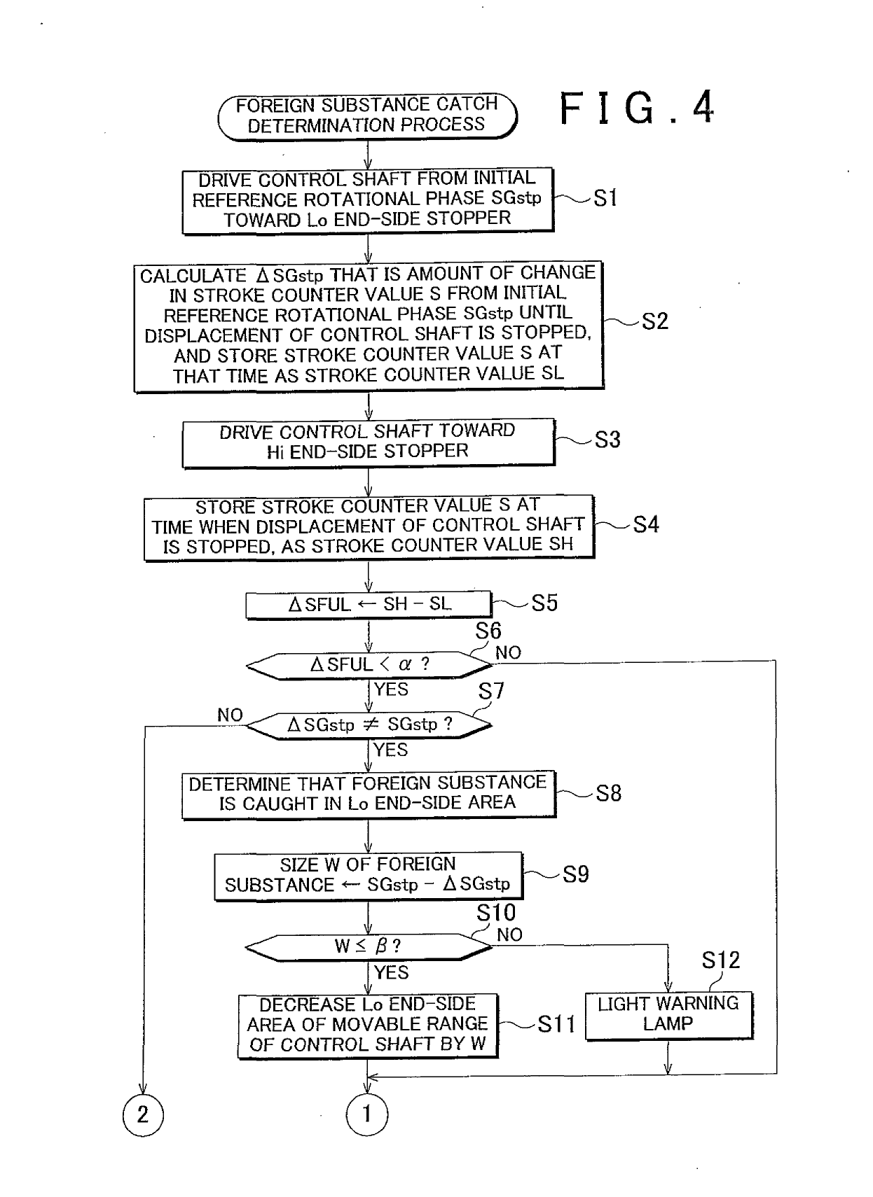

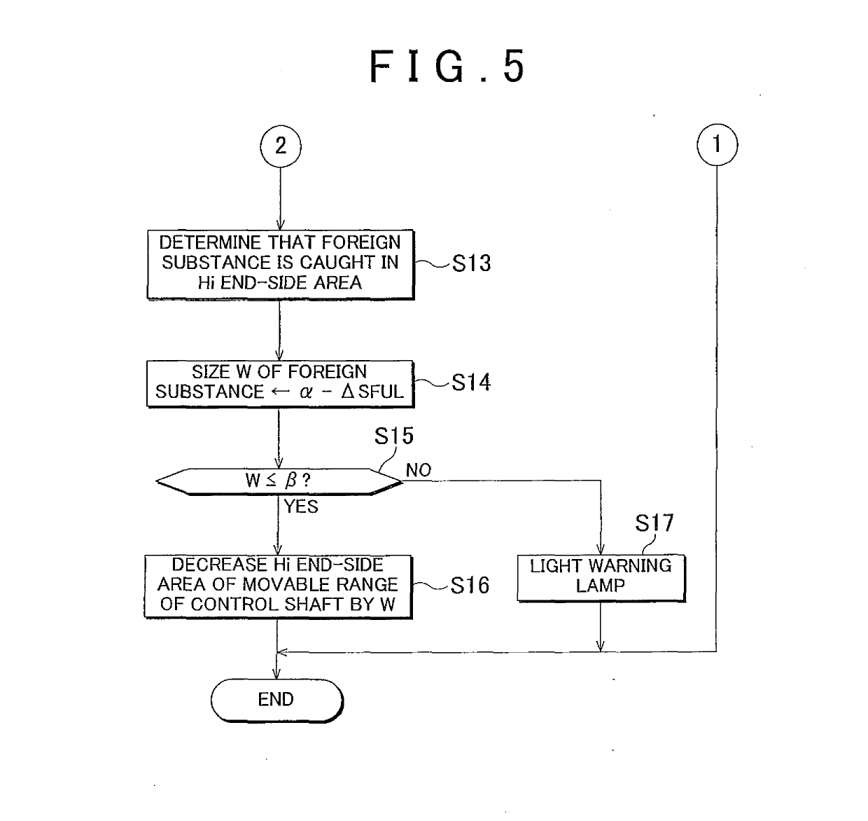

Hereinafter, steps of the foreign substance catch determination process according to the embodiment will be described with reference to FIG. 4 and FIG. 5. The process shown in FIG. 4 and FIG. 5 is performed by the electronic control unit 5 while electric power is supplied to the electronic control unit 5. Also, while the internal combustion engine 1 is operated, the process shown in FIG. 4 and FIG. 5 is performed before the timing at which the Lo end learning process is performed.

As shown in FIG. 4, in the process, first, the control shaft 3 is driven from the initial reference rotational phase SGstp until the engagement portion 31 contacts the Lo end-side stopper 22, in step S1. Then, in step S2, when it is determined that the displacement of the control shaft 3 is stopped, the amount of change in the stroke counter value S from the initial reference rotational phase SGstp until the displacement of the control shaft 3 is stopped (hereinafter, the amount of change will be referred to as “one-side displacement amount ΔSGstp”) is calculated. In this step, the stroke counter value S at the time at which the displacement of the control shaft 3 is stopped is stored as “a stroke counter value SL”.

Next, in step S3, the control shaft 3 is driven until the engagement portion 31 contacts the Hi end-side stopper 21. Then, in step S4, when it is determined that the displacement of the control shaft 3 is stopped, the stroke counter value S at that time is stored as “a stroke counter value SH”. Then, in step S5, a difference between the stroke counter value SH stored in step S4 and the stroke counter value SL stored in step S2 (hereinafter, the difference will be referred to as “a total displacement amount ΔSFUL” (=SH−SL)) is calculated. Then, in step S6, it is determined whether the total displacement amount ΔSFUL is smaller than a predetermined determination value α. The predetermined determination value α is a value set based on the measured value of the distance of the movable range restricted by the Hi end-side stopper 21 and the Lo end-side stopper 22. The value of the distance of the movable range, which is measured immediately after the variable mechanism is assembled, is used. For example, the value of the distance of the movable range, which is measured at the time of shipment from a factory, is used. That is, when no foreign substance is caught, the total displacement amount ΔSFUL is equal to the predetermined determination value a.

If the total displacement amount ΔSFUL is not smaller than the predetermined determination value α (NO in step S6), that is, if the total displacement amount ΔSFUL is equal to the predetermined determination value α, it is regarded that no foreign substance is caught, and thus, the process ends (refer also to FIG. 5).

If the total displacement amount ΔSFUL is smaller than the predetermined determination value α (YES in step S6), it is regarded that a foreign substance is caught in at least the movable range of the control shaft 3, which is restricted by the Hi end-side stopper 21 and the Lo end-side stopper 22, and thus, the routine proceeds to step S7.

The process in step S7 is performed for the following reason. In the case where a foreign matter is caught at the movable area of the variable mechanism 4, particularly in the movable range of the control shaft 3, which is restricted by the Hi end-side stopper 21 and the Lo end-side stopper 22, when the control shaft 3 is driven until the engagement portion 31 contacts the Lo end-side stopper 22, the displacement of the control shaft 3 is restricted and stopped by the foreign substance before the displacement of the control shaft 3 is restricted and stopped by the Lo end-side stopper 22.

In step S7, it is determined whether the one-side displacement amount ΔSGstp calculated in step S2 is unequal to the initial reference rotational phase SGstp. If the one-side displacement amount ΔSGstp calculated in step S2 is equal to the initial reference rotational phase SGstp (NO in step S7), the routine proceeds to step S13 (refer to FIG. 5). In this case, the initial reference rotational phase SGstp may be regarded as the one-side distance according to the invention.

If the one-side displacement amount ΔSGstp is unequal to the initial reference rotational phase SGstp (YES in step S7), there is a high possibility that a foreign substance is caught in the area on the side of the site corresponding to the Lo end-side stopper 22 in the movable range of the control shaft 3, which is restricted by the Hi end-side stopper 21 and the Lo end-side stopper 22. That is, the reason why the total displacement amount ΔSFUL is smaller than the predetermined determination value a and the one-side displacement amount ΔSGstp is unequal to the initial reference rotational phase SGstp is likely to be that a foreign substance is caught in the area on the side of the site corresponding to the Lo end-side stopper 22 in the movable range of the control shaft 3, which is restricted by the Hi end-side stopper 21 and the Lo end-side stopper 22. Thus, the routine proceeds to step S8, and it is determined that a foreign; substance is caught in the Lo end-side area, that is, the area on the side of the Lo end, in other words, the area on the side of the site corresponding to the Lo end-side stopper 22 in step S8. Next, in step S9, a difference (=SGstp−ΔSGstp) between the initial reference rotational phase SGstp and the one-side displacement amount ΔSGstp is calculated as a size W of the foreign substance. Next, in step S10, it is determined whether the size W of the foreign substance is equal to or smaller than a predetermined value β. Note that in the embodiment, the control range of the control shaft 3 is set so that each of both ends of the control range is closer to the center of the movable range of the control shaft 3 than the corresponding end of the movable range by the predetermined value β. The movable range of the control shaft 3 is restricted by the Hi end-side stopper 21 and the Lo end-side stopper 22.

If the size W of the foreign substance is equal to or smaller than the predetermined value β (YES in step S10), the control range of the control shaft 3 is not influenced by the foreign substance. Therefore, the routine proceeds to step S11, and the Lo end-side area of the movable range of the control shaft 3 is corrected so as to be decreased by the calculated size W of the foreign substance in step S11.

If the size W of the foreign substance is larger than the predetermined value β (NO in step S10), the control range of the control shaft 3 is influenced by the foreign substance. Therefore, even if the movable range of the control shaft 3 is corrected so as to be decreased based on the size W of the foreign substance as in step S11, it is not possible to appropriately change the maximum lift amount of the engine valve. Therefore, the routine proceeds to step S12, and a warning lamp is lit in step S12, and then, the process ends. The warning lamp may be provided in an instrument in a vehicle cabin so that a driver can easily recognize the warning lamp.

As shown in FIG. 4 and FIG. 5, if the one-side displacement amount ΔSGstp is equal to the initial reference rotational phase SGstp in step S7, there is a high possibility that a foreign substance is caught in an area on the side of a site corresponding to the Hi end-side stopper 21 in the movable range of the control shaft 3, which is restricted by the Hi end-side stopper 21 and the Lo end-side stopper 22. Therefore, the routine proceeds to step S13, and it is determined that a foreign substance is caught in the Hi end-side area, that is, the area on the side of the Hi end, in other words, the area on the side of the site corresponding to the Hi end-side stopper 21 in step S13. Next, in step S14, a difference (=α−ΔSFUL) between the predetermined determination value α and the total displacement amount ΔSFUL is calculated as the size W of the foreign substance. Next, in step S15, it is determined whether the calculated size W of the foreign substance is equal to or smaller than the predetermined value β.

If the size W of the foreign substance is equal to or smaller than the predetermined value β (YES in step S15), the control range of the control shaft 3 is not influenced by the foreign substance. Therefore, the routine proceeds to step S16, and the Hi end-side area of the movable range of the control shaft 3 is corrected so as to be decreased by the calculated size W of the foreign substance.

If the size W of the foreign substance is larger than the predetermined value β (NO in step S15), the control range of the control shaft 3 is influenced by the foreign substance. Therefore, even if the movable range of the control shaft is corrected so as to be decreased based on the size W of the foreign substance as in step S16, it is not possible to appropriately change the maximum lift amount of the engine valve. Therefore, the routine proceeds to step S17, and the warning lamp is lit in step S17, and then, the process ends.

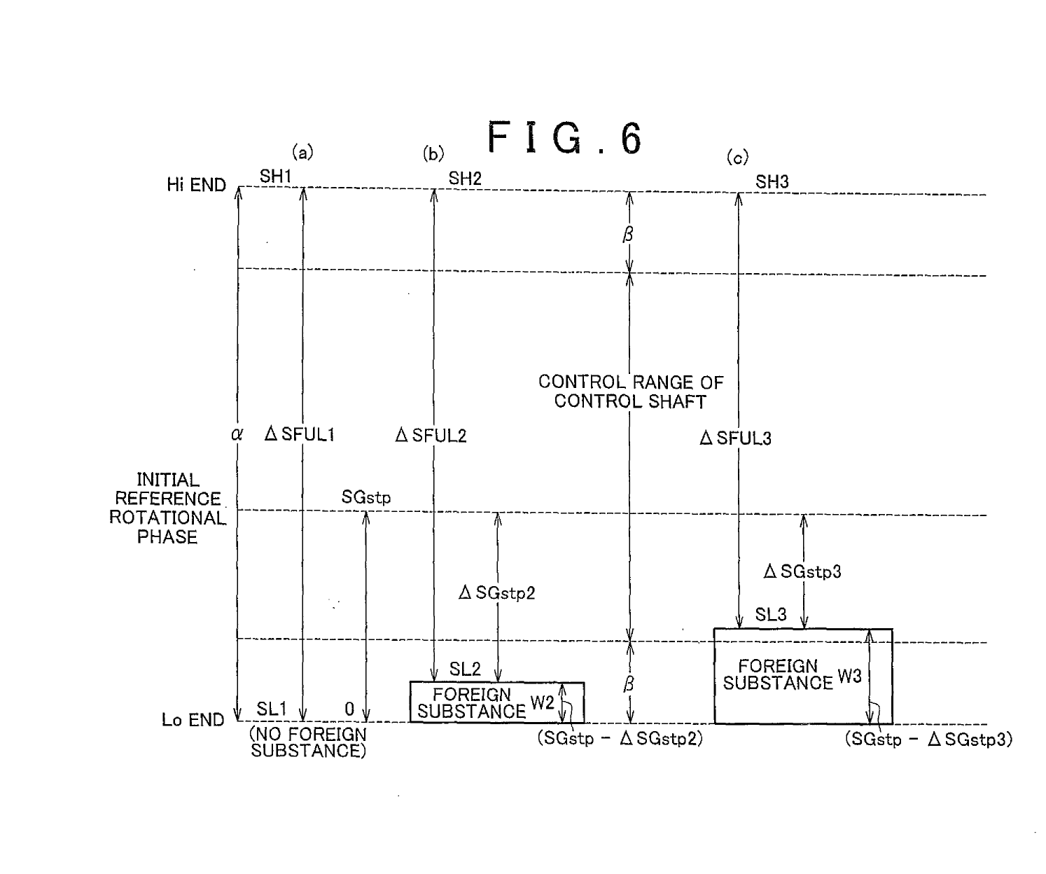

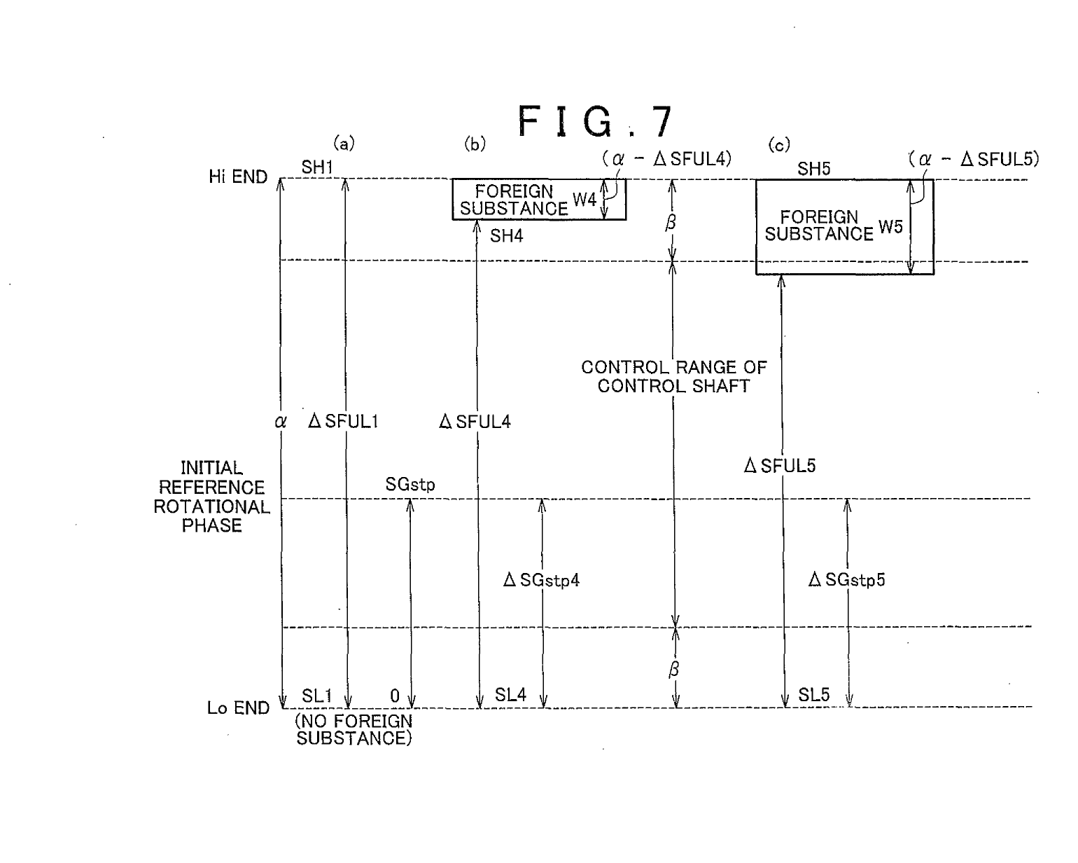

Next, the advantageous effects obtained in the embodiment will be described with reference to FIG. 6 and FIG. 7. As shown in a portion (a) of FIG. 6, if no foreign substance is caught, a total displacement amount ΔSFUL1 (=SH1−SL1, S1=0) is equal to the predetermined determination value α (NO in step S6 in FIG. 4).

If a foreign substance is caught in the Lo end-side area, a total displacement amount ΔSFUL2 (=SH2−SL2) is smaller than the predetermined determination value α as shown in a portion (b) of FIG. 6, and a total displacement amount ΔFUL3 (=SH3−SL3) is smaller than the predetermined determination value a as shown in a portion (c) of FIG. 6 (YES step S6). In these cases, each of a one-side displacement amount ΔSGstp2 and a one-side displacement amount ΔSGstp3 is smaller than the initial reference rotational phase SGstp, and is unequal to the initial reference rotational phase SGstp (YES in step S7).

If a foreign substance is caught as shown in the portion (b) of FIG. 6, a size W2 of the foreign substance, which is calculated as a difference (=SGstp−ΔSGstp2) between the initial reference rotational phase SGstp and the one-side displacement amount ΔSGstp2, is equal to or smaller than the predetermined value β (YES in step S10). Therefore, the control range of the control shaft 3 is not influenced. Accordingly, the movable range of the control shaft 3, which is restricted by the size W2 of the foreign substance, is used as a new movable range (step S11).

In contrast, if a foreign substance is caught as shown in the portion (c) of FIG. 6, a size W3 of the foreign substance, which is calculated as a difference (=SGstp−ΔSGstp3) between the initial reference rotational phase SGstp and the one-side displacement amount ΔSGstp3, is larger than the predetermined value β (NO in step S10). Therefore, the control range of the control shaft 3 is influenced. Accordingly, in this case, the movable range of the control shaft 3 is not corrected, and the warning lamp is lit (step S12).

If a foreign substance is caught in the Hi end-side area, a total displacement amount ΔSFUL4 (=SH4−SL4) is smaller than the predetermined determination value α as shown in a portion (b) of FIG. 7, and a total displacement amount ΔSFUL5 (=SH5−SL5) is smaller than the predetermined determination value a as shown in a portion (c) of FIG. 7 (YES step S6). In these cases, each of a one-side displacement amount ΔSGstp4 and a one-side displacement amount ΔSGstp5 is equal to the initial reference rotational phase SGstp (NO in step S7).

If a foreign substance is caught as shown in the portion (b) of FIG. 7, a size W4 of the foreign substance, which is calculated as a difference (=α−ΔSFUL4) between the predetermined determination value α and the total displacement amount ΔSFUL4, is equal to or smaller than the predetermined value β (YES in step S15). Therefore, the control range of the control shaft 3 is not influenced. Accordingly, the movable range of the control shaft 3, which is restricted by the size W4 of the foreign substance, is used as a new movable range (step S16).

In contrast, if a foreign substance is caught as shown, in the portion (c) of FIG. 7, a size W5 of the foreign substance, which is calculated as a difference (=α−ΔSFUL5) between the predetermined determination value α and the total displacement amount ΔSFUL5, is larger than the predetermined value β(NO in step S15). Therefore, the control range of the control shaft 3 is influenced. Accordingly, in this case, the movable range of the control shaft 3 is not corrected, and the warning lamp is lit (step S17).

With the control apparatus for the variable mechanism according the embodiment that has been described, it is possible to obtain the following advantageous effects. (1) In the embodiment, when electric power is supplied to the electronic control unit 5, the electronic control unit 5 drives the control shaft 3 from the initial reference rotational phase SGstp learned when the supply of electric power was stopped most recently before electric power is supplied to the electronic control unit 5, until the engagement portion 31 contacts the Lo end-side stopper 22. Then, the electronic control unit 5 calculates the one-side displacement amount ΔSGstp. The one-side displacement amount ΔSGstp is the amount of displacement of the control shaft 3 from the initial reference rotational phase SGstp until it is determined that the displacement of the control shaft 3 is stopped. If the one-side displacement amount ΔSGstp is smaller than the initial reference rotational phase SGstp (ΔSGstp<SGstp), it is determined that a foreign substance is caught in the area on the side of the site corresponding to the Lo end-side stopper 22 in the movable range of the control shaft 3, which is restricted by the Hi end-side stopper 21 and the Lo end-side stopper 22.

In the embodiment, when the supply of electric power to the electronic control unit 5 is stopped, the stroke counter value S indicating the absolute position of the control shaft 3 at that time is learned as the initial reference rotational phase SGstp. Then, when electric power is supplied to the electronic control unit 5, the control shaft 3 is driven from the initial reference rotational phase SGstp learned when the supply of electric power was stopped most recently before electric power is supplied to the electronic control unit 5, until the engagement portion 31 contacts the Lo end-side stopper 22. Then, the one-side displacement amount ΔSGstp is calculated. The one-side displacement amount ΔSGstp is the amount of displacement of the control shaft 3 from the initial reference rotational phase SGstp until it is determined that the displacement of the control shaft 3 is stopped. In the case where the reference position was learned due to the fulfillment of the predetermined learning condition when electric power was supplied to the electronic control unit 5 most recently before the supply of electric power was stopped, and a foreign substance got caught after the reference position was learned, the one-side displacement amount ΔSGstp is smaller than the initial reference rotational phase SGstp. Accordingly, when a foreign substance is caught in the area on the side of the site corresponding to the Lo end-side stopper 22 in the movable range of the control shaft 3, which is restricted by the Hi end-side stopper 21 and the Lo end-side stopper 22, it is possible to accurately determine that a foreign substance is caught in the area on the side of the site corresponding to the Lo end-side stopper 22.

(2) In the embodiment, the control shaft 3 is driven until the engagement portion 31 contacts the La end-side stopper 22, and when it is determined that the displacement of the control shaft 3 is stopped, the stroke counter value SL is calculated. In addition, the control shaft 3 is driven until the engagement portion 31 contacts the Hi end-side stopper 21, and when it is determined that the displacement of the control shaft 3 is stopped, the stroke counter value SH of the control shaft 3 is calculated. Then, the total displacement amount ΔSFUL (=SH−SL), which is the difference between the stroke counter values SL and SH, is calculated. If the total displacement amount ΔSFUL is smaller than the predetermined determination value α (ΔSFUL<α), a determination regarding the catching of a foreign substance is performed based on the comparison between the one-side displacement amount ΔSGstp and the initial reference rotational phase SGstp. The predetermined determination value α is set based on the measured value of the distance of the movable range restricted by the Hi end-side stopper 21 and the Lo end-side stopper 22.

The calculated stroke counter value S (i.e., the absolute position of the control shaft 3) may deviate from the actual position due to, for example, changes in the characteristics of the electric angle sensors D1 to D3 and the position sensors S1 and S2. In the case where the calculated stroke counter value S deviates from the actual position, even if no foreign substance is caught in the area on the side of the site corresponding to the Lo end-side stopper 22 in the movable range of the control shaft 3, which is restricted by the Hi end-side stopper 21 and the Lo end-side stopper 22, the one-side displacement amount ΔSGstp may be smaller than the initial reference rotational phase SGstp, and as a result, it may be erroneously determined that a foreign substance is caught.

In this regard, in the embodiment, if the calculated total displacement amount ΔSFUL is smaller than the predetermined determination value α (ΔSFUL<α), the determination is performed based on the comparison between the one-side displacement amount ΔSGstp and the initial reference rotational phase SGstp, because there is a high possibility that a foreign substance is caught in the movable range of the control shaft 3, which is restricted by the Hi end-side stopper 21 and the Lo end-side stopper 22. Thus, it is possible to reduce the possibility of making an erroneous determination that a foreign substance is caught when no foreign substance is caught.

(3) In the embodiment, if it is determined that a foreign substance is caught in the area on the side of the site corresponding to the Lo end-side stopper 22 in the movable range of the control shaft 3, which is restricted by the Hi end-side stopper 21 and the Lo end-side stopper 22, the size W of the foreign substance is calculated based on the difference (=SGstp−ΔSGstp) between the initial reference rotational phase SGstp and the one-side displacement amount ΔSGstp. Then, the movable range of the control shaft 3 is corrected so as to be decreased based on the calculated size W of the foreign substance.

If the control that operates the variable mechanism 4 is continued after it is determined that a foreign substance is caught in the area on the side of the site corresponding to the Lo end-side stopper 22 in the movable range of the control shaft 3, which is restricted by the Hi end-side stopper 21 and the Lo end-side stopper 22, the following situation may occur. If the reference position is newly learned due to the fulfillment of the predetermined learning condition after it is determined that a foreign substance is caught in the area on the side of the site corresponding to the Lo end-side stopper 22, the stroke counter value S calculated based on the newly learned reference position deviates from the actual position due to the foreign substance being caught, after the completion of the learning. As a result, it becomes impossible to appropriately change the maximum lift amount of the engine valve.

In this regard, in the embodiment, when the reference position is learned due to the fulfillment of the predetermined learning condition, the movable range of the control shaft 3 is corrected so as to be decreased based on the calculated size W of the foreign substance. Accordingly, if the reference position is learned due to the fulfillment of the predetermined learning condition after it is determined that a foreign substance is caught in the area on the side of the site corresponding to the Lo end-side stopper 22, it is possible to reduce the possibility that the stroke counter value S calculated based on the newly learned reference position deviates from the actual position, after the completion of the learning. Also, as the size of the foreign substance that is caught becomes larger, the calculated one-side displacement amount ΔSGstp becomes smaller with respect to the initial reference rotational phase SGstp. Therefore, the size W of the foreign substance is accurately calculated based on the difference between the initial reference rotational phase SGstp and the one-side displacement amount ΔSGstp.

(4) In the embodiment, if the calculated size W of the foreign substance is larger than the predetermined value β, the warning command is output, that is, the warning command is output to light the warning lamp. Even in the case where the size W of the foreign substance caught in the area on the side of the site corresponding to the Lo end-side stopper 22 in the movable range of the control shaft 3, which is restricted by the Hi end-side stopper 21 and the Lo end-side stopper 22, is calculated and the movable range of the control shaft 3 is corrected so as to be decreased based on the size W of the foreign substance, if the size W of the foreign substance is excessively large, it is not possible to appropriately change the maximum lift amount of the engine valve.

In this regard, in the embodiment, if the calculated size W of the foreign substance is larger than the predetermined value β, the warning command is output. Therefore, when the maximum lift amount of the engine valve cannot be appropriately changed, it is possible to quickly notify the driver of this situation.

(5) In the embodiment, if the total displacement amount ΔSFUL is smaller than the predetermined determination value α and the one-side displacement amount ΔSGstp is equal to the initial reference rotational phase SGstp (ΔSGstp=SGstp), it is determined that a foreign substance is caught in the area on the side of the site corresponding to the Hi end-side stopper 21 in the movable range of the control shaft 3, which is restricted by the Hi end-side stopper 21 and the Lo end-side stopper 22.

If the total displacement amount ΔSFUL is smaller than the predetermined determination value α and the one-side displacement amount ΔSGstp is equal to the initial reference rotational phase SGstp, there is a high possibility that a foreign substance is caught in the area on the side of the site corresponding to the Hi end-side stopper 21 in the movable range of the control shaft 3, which is restricted by the Hi end-side stopper 21 and the Lo end-side stopper 22. In this regard, in the embodiment, it is possible to accurately determine that a foreign substance is caught in the area on the side of the site corresponding to the Hi end-side stopper 21 in the movable range of the control shaft 3, which is restricted by the Hi end-side stopper 21 and the Lo end-side stopper 22.

(6) In the embodiment, if it is determined that a foreign substance is caught in the area on the side of the site corresponding to the Hi end-side stopper 21 in the movable range of the control shaft 3, which is restricted by the Hi end-side stopper 21 and the Lo end-side stopper 22, the size W of the foreign substance is calculated based on the difference (=α−ΔSFUL) between the predetermined determination value α and the total displacement amount ΔSFUL. Then, the movable range of the control shaft 3 is corrected so as to be decreased based on the calculated size W of the foreign substance.

If the control that operates the variable mechanism 4 is continued after it is determined that a foreign substance is caught in the area on the side of the site corresponding to the Hi end-side stopper 21 in the movable range of the control shaft 3, which is restricted by the Hi end-side stopper 21 and the Lo end-side stopper 22, the following situation may occur. Because the electronic control unit 5 permits the control shaft 3 to be driven in the entire movable range, for example, if an attempt is made to drive the control shaft 3 until the engagement portion 31 contacts the Hi end-side stopper 21, the displacement of the control shaft 3 is restricted by the foreign substance, and thus, it becomes impossible to appropriately change the maximum lift amount of the engine valve.

In this regard, in the embodiment, the movable range of the control shaft 3 is corrected so as to be decreased based on the calculated size W of the foreign substance. Accordingly, the electronic control unit 5 drives the control shaft 3 in the movable range in which the area on the side of the site corresponding to the Hi end-side stopper 21 has been corrected so as to be decreased. Thus, it is possible to accurately correct the movable range taking into account the foreign substance that is caught. Therefore, it is possible to reduce the possibility that the maximum lift amount of the engine valve cannot be appropriately changed. Also, as the size of the foreign substance that is caught becomes larger, the calculated total displacement amount ΔSFUL becomes smaller with respect to the predetermined determination value α. Therefore, the size W of the foreign substance is accurately calculated based on the difference between the predetermined determination value α and the total displacement amount ΔSFUL.

(7) In the embodiment, if the calculated size W of the foreign substance is larger than the predetermined value β, the warning command is output through the electronic control unit 5. Even in the case where the size W of the foreign substance caught in the area on the side of the site corresponding to the Hi end-side stopper 21 in the movable range of the control shaft 3, which is restricted by the Hi end-side stopper 21 and the Lo end-side stopper 22, is calculated and the movable range of the control shaft 3 is corrected so as to be decreased based on the size W of the foreign substance, if the size W of the foreign substance is excessively large, it is not possible to appropriately change the maximum lift amount of the engine valve.

In this regard, in the embodiment, if the calculated size W of the foreign substance is larger than the predetermined value β, the warning command is output, Therefore, when the maximum lift amount of the engine valve cannot be appropriately changed, it is possible to quickly notify the driver of this situation.

The configuration of the control apparatus for a variable mechanism according to the invention is not limited to the configuration described in the embodiment. For example, the control apparatus for a variable mechanism according to the invention may be implemented in the following examples obtained by appropriately changing the above-described embodiment.

In the embodiment, if the total displacement amount ΔSFUL is smaller than the predetermined determination value α and the one-side displacement amount ΔSGstp is equal to the initial reference rotational phase SGstp (ΔSGstp=SGstp), it is determined that a foreign substance is caught in the area on the side of the site corresponding to the Hi end-side stopper 21 in the above-described movable range. That is, it is accurately detect the situation where a foreign substance is caught in one of the Lo end-side area and the Hi end-side area in the movable range. The situation may occur where foreign substances are caught in both of the Lo end-side area and the Hi end-side area in the movable range. However, in the above-described embodiment, it is not possible to accurately detect this situation. Accordingly, the determination may be performed in the following manner, instead of performing the determination in the above-described manner. That is, it may be determined that a foreign substance is caught in the area on the side of the site corresponding to the Hi end-side stopper 21 in the movable range, if the total displacement amount ΔSFUL is smaller than the predetermined determination value α, and a difference between the initial reference rotational phase SGstp and the one-side displacement amount ΔSGstp (hereinafter, the difference will be referred to as “one-side difference A” (=SGstp−ΔSGstp)) is smaller than a difference between the predetermined determination value α and the total displacement amount ΔSFUL (hereinafter, the difference will be referred to as “total difference B” (=α−ΔSFUL)), that is, the one-side difference A is smaller than the total difference B (A<B). Thus, even in the case where the one-side displacement amount ΔSGstp is unequal to the initial reference rotational phase SGstp (ΔSGstp≠SGstp), that is, even in the case where a foreign substance is caught in the Lo end-side area, when a foreign substance is caught in the Hi end-side area, it is possible to accurately detect that a foreign substance is caught in the Hi end-side area.

Also, in this case, if it is determined that a foreign substance is caught in the area on the side of the site corresponding to the Hi end-side stopper 21 in the movable range, the size W of the foreign substance may be calculated based on the difference (=B−A) between the total difference B and the one-side difference A, and the movable range of the control shaft may be corrected so as to be decreased based on the size W of the foreign substance.

In the embodiment, the size W of the foreign substance that is caught is calculated, and the movable range of the control shaft 3 is corrected so as to be decreased or the warning lamp is lit, based on the size W of the foreign substance. However, the invention is not limited to this configuration. If it is determined that a foreign substance is caught in the Lo end-side area or the Hi end-side area, the warning lamp may be lit without calculating the size of the foreign substance.

In the embodiment, the total displacement amount ΔSFUL is calculated, and if the total displacement amount ΔSFUL is smaller than the predetermined determination value α, the determination is performed based on the comparison between the one-side displacement amount ΔSGstp and the initial reference rotational phase SGstp (one-side distance), because there is a high possibility that a foreign substance is caught in the movable range of the control shaft 3. This configuration is desirable for reducing the possibility of making an erroneous determination that a foreign substance is caught due to, for example, changes in the characteristics of the electric angle sensors D1 to D3 and the position sensors S1 and S2 when no foreign substance is caught. However, when it is possible to detect, using another configuration, that the calculated stroke counter value S (i.e., the absolute position of the control shaft 3) deviates from the actual position due to, for example, changes in the characteristics of the electric angle sensors D1 to D3 and the position sensors S1 and S2, the calculation of the total displacement amount ΔSFUL and the comparison between the total displacement amount ΔSFUL and the predetermined determination value α, which are performed in the embodiment, may be omitted.

In the embodiment, the invention is applied to the control apparatus for the variable mechanism that changes the maximum lift amount of the intake valve of the internal combustion engine. However, the variable mechanism according to the invention is not limited to this variable mechanism. For example, the variable mechanism according to the invention may be a variable mechanism that changes the maximum lift amount of an exhaust valve. Also, the variable mechanism according to the invention is not limited to the variable mechanism that changes the characteristic of the valve of the internal combustion engine. Any variable mechanism may be employed as the variable mechanism according to the invention, as long as in the variable mechanism, an actuator drives a movable member to change a predetermined mechanical characteristic of an object to be controlled.

1.-19. (canceled)

20. A control apparatus for a variable mechanism that includes a movable member including an engagement portion that reciprocates between two restriction members, and an actuator that drives the movable member, wherein in the variable mechanism, the actuator drives the movable member to change a predetermined mechanical characteristic of an object to be controlled, the control apparatus comprising:
a displacement amount calculation portion that calculates an amount of displacement of the movable member from a reference position;
an absolute position calculation portion that calculates an absolute position of the movable member based on the reference position and the amount of displacement of the movable member from the reference position;
a movement control portion that controls movement of the movable member using the actuator based on the absolute position;
a learning portion that, when a predetermined condition is fulfilled, drives the movable member until the engagement portion contacts one of the two restriction members, and learns the absolute position of the movable member at a time at which it is determined that displacement of the movable member is stopped, as the reference position corresponding to the one of the two restriction members, wherein when supply of electric power to the control apparatus is stopped, the learning portion learns the absolute position of the movable member at a time at which an operation of the actuator is stopped, as an initial reference position;
a one-side displacement amount calculation portion that, when electric power is supplied to the control apparatus, drives the movable member from the initial reference position learned when the supply of electric power was stopped most recently before electric power is supplied to the control apparatus, until the engagement portion contacts the one of the two restriction members, wherein the one-side displacement amount calculation portion calculates a one-side displacement amount that is the amount of displacement of the movable member from the initial reference position until it is determined that the displacement of the movable member is stopped;
a one-side distance calculation portion that calculates a one-side distance that is a distance from the initial reference position to the reference position learned due to fulfillment of the predetermined condition before the initial reference position was learned;
a determination portion that determines that a foreign substance is caught in an area on a side of a site corresponding to the one of the two restriction members in a movable range of the movable member, which is restricted by the two restriction members, if the one-side displacement amount is smaller than the one-side distance; and
a total displacement amount calculation portion that drives the movable member until the engagement portion contacts one of the two restriction members, and calculates the absolute position of the movable member at a time at which it is determined that the displacement of the movable member is stopped, and that drives the movable member until the engagement portion contacts the other of the two restriction members, calculates the absolute position of the movable member at a time at which it is determined that the displacement of the movable member is stopped, and calculates a total displacement amount that is an amount of displacement of the movable member between the two absolute positions, wherein if the total displacement amount is smaller than a predetermined determination value, the determination portion performs a determination regarding catching of the foreign substance, based on comparison between the one-side displacement amount and the one-side distance.

21. The control apparatus according to claim 20, wherein
the predetermined determination value is set based on a measured value of a distance of the movable range restricted by the two restriction members.

22. The control apparatus according claim 20, wherein
if the determination portion determines that a foreign substance is caught in the area on the side of the site corresponding to the one of the two restriction members in the movable range of the movable member, which is restricted by the two restriction members, the control apparatus calculates a size of the foreign substance based on a difference between the one-side distance and the one-side displacement amount, and corrects the movable range of the movable member so as to decrease the movable range based on the size of the foreign substance.

23. The control apparatus according to claim 22, wherein
if the calculated size of the foreign substance is larger than a predetermined value, the control apparatus outputs a warning command.

24. The control apparatus according to claim 23, wherein
if the calculated size of the foreign substance is equal to or smaller than the predetermined value, the control apparatus corrects the movable range of the movable member so as to decrease the movable range by the calculated size of the foreign substance; and
if the calculated size of the foreign substance is larger than the predetermined value, the control apparatus does not correct the movable range, and outputs the warning command.

25. The control apparatus according to claim 24, wherein
if the calculated size of the foreign substance is larger than the predetermined value, the control apparatus does not correct the movable range, and outputs the warning command to light a warning lamp.

26. The control apparatus according to claim 21, wherein
the predetermined determination value is set based on a measured value of a distance of the movable range restricted by the two restriction members; and
if the total displacement amount is smaller than the predetermined determination value and the one-side displacement amount is equal to the one-side distance, the determination portion determines that a foreign substance is caught in an area on a side of a site corresponding to the other of the two restriction members in the movable range of the movable member, which is restricted by the two restriction members.

27. The control apparatus according to claim 26, wherein
if the determination portion determines that a foreign substance is caught in the area on the side of the site corresponding to the other of the two restriction members in the movable range of the movable member, which is restricted by the two restriction members, the control apparatus calculates a size of the foreign substance based on a difference between the predetermined determination value and the total displacement amount, and the control apparatus corrects the movable range of the movable member so as to decrease the movable range based on the size of the foreign substance.

28. The control apparatus according to claim 21, wherein
the predetermined determination value is set based on a measured value of a distance of the movable range restricted by the two restriction members; and
if the total displacement amount is smaller than the predetermined determination value and a difference between the one-side distance and the one-side displacement amount is smaller than a difference between the predetermined determination value and the total displacement amount, the determination portion determines that a foreign substance is caught in an area on a side of a site corresponding to the other of the two restriction members in the movable range of the movable member, which is restricted by the two restriction members.

29. The control apparatus according to claim 28, wherein
if the determination portion determines that a foreign substance is caught in the area on the side of the site corresponding to the other of the two restriction members in the movable range of the movable member, which is restricted by the two restriction members, the control apparatus calculates a size of the foreign substance based on a difference between a total difference and a one-side difference, and the control apparatus corrects the movable range of the movable member so as to decrease the movable range based on the size of the foreign substance, the total difference being a difference between the predetermined determination value and the total displacement amount, and the one-side difference being a difference between the one-side distance and the one-side displacement amount.

30. The control apparatus according to claim 28, wherein
if the calculated size of the foreign substance is larger than a predetermined value, the control apparatus outputs a warning command.

31. The control apparatus according to claim 30, wherein
if the calculated size of the foreign substance is equal to or smaller than the predetermined value, the control apparatus corrects the movable range of the movable member so as to decrease the movable range by the calculated size of the foreign substance; and
if the calculated size of the foreign substance is larger than the predetermined value, the control apparatus does not correct the movable range, and outputs the warning command.

32. The control apparatus according to claim 31, wherein
if the calculated size of the foreign substance is larger than the predetermined value, the control apparatus does not correct the movable range, and outputs the warning command to light a warning lamp.

33. The control apparatus according to claim 20, wherein
the variable mechanism changes a characteristic of a valve of an internal combustion engine.

34. A control method for a variable mechanism that includes a movable member including an engagement portion that reciprocates between two restriction members, and an actuator that drives the movable member, wherein in the variable mechanism, the actuator drives the movable member to change a predetermined mechanical characteristic of an object to be controlled, and the control method is performed by a control apparatus, the control method comprising:
calculating an amount of displacement of the movable member from a reference position;
calculating an absolute position of the movable member based on the reference position and the amount of displacement of the movable member from the reference position;
controlling movement of the movable member using the actuator based on the absolute position;
when a predetermined condition is fulfilled, driving the movable member until the engagement portion contacts one of the two restriction members, and learning the absolute position of the movable member at a time at which it is determined that displacement of the movable member is stopped, as the reference position corresponding to the one of the two restriction members;
when supply of electric power to the control apparatus is stopped, learning the absolute position of the movable member at a time at which an operation of the actuator is stopped, as an initial reference position;
when electric power is supplied to the control apparatus, driving the movable member from the initial reference position learned when the supply of electric power was stopped most recently before electric power is supplied to the control apparatus, until the engagement portion contacts the one of the two restriction members, and calculating a one-side displacement amount that is the amount of displacement of the movable member from the initial reference position until it is determined that the displacement of the movable member is stopped;
calculating a one-side distance that is a distance from the initial reference position to the reference position learned due to fulfillment of the predetermined condition before the initial reference position was learned;
determining that a foreign substance is caught in an area on a side of a site corresponding to the one of the two restriction members in a movable range of the movable member, which is restricted by the two restriction members, if the one-side displacement amount is smaller than the one-side distance; and
driving the movable member until the engagement portion contacts one of the two restriction members, calculating the absolute position of the movable member at a time at which it is determined that the displacement of the movable member is stopped, driving the movable member until the engagement portion contacts the other of the two restriction members, calculating the absolute position of the movable member at a time at which it is determined that the displacement of the movable member is stopped, and calculating a total displacement amount that is an amount of displacement of the movable member between the two absolute positions; and
if the total displacement amount is smaller than a predetermined determination value, performing a determination regarding catching of the foreign substance based on comparison between the one-side displacement amount and the one-side distance.

35. The control method according to claim 34, wherein
the predetermined determination value is set based on a measured value of distance of the movable range restricted by the two restriction members; and
the control method further comprises determining that a foreign substance is caught in an area on a side of a site corresponding to the other of the two restriction members in the movable range of the movable member, which is restricted by the two restriction members, if the total displacement amount is smaller than the predetermined determination value and the one-side displacement amount is equal to the one-side distance.

36. The control method according to claim 34, wherein
the predetermined determination value is set based on a measured value of a distance of the movable range restricted by the two restriction members; and
the control method further comprises determining that a foreign substance is caught in an area on a side of a site corresponding to the other of the two restriction members in the movable range of the movable member, which is restricted by the two restriction members, if the total displacement amount is smaller than the predetermined determination value and a difference between the one-side distance and the one-side displacement amount is smaller than a difference between the predetermined determination value and the total displacement amount.
